(19) United States
(12) Patent Application Publication
(10) Pub. No.: US 2026/0287780 A1
(43) Pub. Date: Sep. 24, 2026

(54) NEUTRON BACKSCATTER TOOL BACKGROUND STANDARD FOR GEOCHEMICAL LOGGING IN WELL SYSTEMS

(71) Applicant: Halliburton Energy Services, Inc., Houston, TX (US)

(72) Inventors: Gregory Joseph Schmid, Houston, TX (US); Jeffrey James Crawford, Houston, TX (US)

(21) Appl. No.: 19/088,453

(22) Filed: Mar. 24, 2025

(51) Int. Cl. G01V 5/10; E21B 49/00

(52) U.S. Cl. CPC G01V 5/104; E21B 49/00

(57) ABSTRACT

Systems, methods, and apparatus, including computer programs encoded on computer-readable media, for performing geochemical logging in a well system. Spectrum data associated with a subsurface formation may be obtained using a geochemical logging tool of the well system that implements neutron-induced gamma ray spectroscopy. A spectral fit relating to the spectrum data may be determined based on two or more tool background standard spectra and one or more elemental standard spectra. The two or more tool background standard spectra may be independent tool background standard spectra and may include at least a direct tool background standard spectrum and an indirect backscatter tool background standard spectrum. An elemental composition of the subsurface formation may be determined based on the spectral fit.

### TECHNICAL FIELD

The present invention relates generally to oil and gas systems and services, and more specifically to a neutron backscatter tool background standard for geochemical logging in well systems.

### BACKGROUND

The oil and gas services industry uses various types of well equipment and tools in well systems at well sites. Well systems may use downhole geochemical logging tools for geochemical logging of the subsurface formation of a well for hydrocarbon reservoir evaluation and hydrocarbon extraction. The downhole geochemical logging tools may include neutron-induced gamma ray spectroscopy tools. Neutron-induced gamma ray spectroscopy tools typically release neutrons into the geological subsurface formation and measure the gamma ray spectra created when the neutrons interact with the elements in the formation. These interactions can occur through inelastic scattering, where fast neutrons collide with the formation elements, or neutron capture, where thermal neutrons are absorbed by the nuclei of the formation elements. The gamma rays produced have varying energy levels, which are detected by sensors in the spectroscopy tool to provide useful spectrum data. By analyzing these spectra at different depths, various subsurface formation and well properties can be determined. However, some gamma rays may also come from the tool's materials, generating background noise that reduces the signal-to-noise ratio (SNR) of the measurements. Interactions close to the detector can increase this noise, even with low neutron flux. Although some noise can be removed during processing, the noise can still impact the precision and accuracy of the spectrum data readings.

### BRIEF DESCRIPTION OF THE DRAWINGS

FIG. 1 depicts a schematic diagram of an example well system including a geochemical logging tool, according to some implementations.

FIG. 2A depicts an example inelastic spectral plot that uses a direct tool background standard and elemental standards for an accurate spectral fit when the subsurface formation has a high porosity, according to some implementations.

FIG. 2B depicts an example inelastic spectral plot that shows a poor spectral fit when the direct tool background and the elemental standards are used for a subsurface formation that has a low porosity, according to some implementations.

FIG. 3 depicts an example inelastic spectral plot that uses an indirect backscatter tool background standard, a direct tool background standard, and elemental standards for an accurate spectral fit when the subsurface formation has a low porosity, according to some implementations.

FIG. 4 depicts a flowchart of example operations for using two or more tool background standards and the elemental standards for obtaining an accurate spectral fit for a subsurface formation, according to some implementations.

FIG. 5 depicts a flowchart of example operations for deriving the indirect backscatter tool background standard, according to some implementations.

FIG. 6 is a flowchart of example operations for performing geochemical logging in a well system, according to some implementations.

FIG. 7 depicts an example computer system of a well system for processing spectrum data obtained from a spectroscopy tool, according to some implementations.

FIG. 8 is a schematic diagram of a drilling rig system, as an example of oil services systems that use surface and downhole equipment.

### DESCRIPTION

The description that follows includes example systems, methods, techniques, and program flows that describe aspects of the disclosure. However, it is understood that this disclosure may be practiced without these specific details. For instance, this disclosure refers to certain well systems, devices, or tools in illustrative examples. Aspects of this disclosure can be instead applied to other types of well systems, devices, and tools. In other instances, well-known instruction instances, protocols, structures, and techniques have not been shown in detail to avoid confusion.

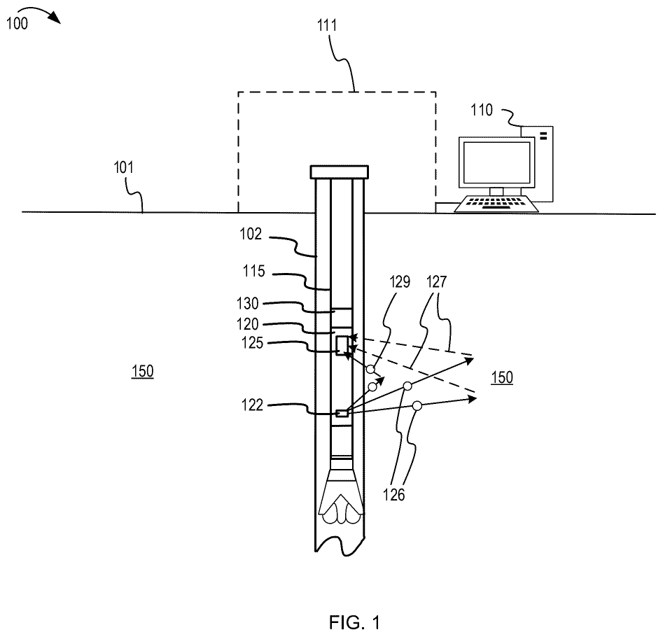

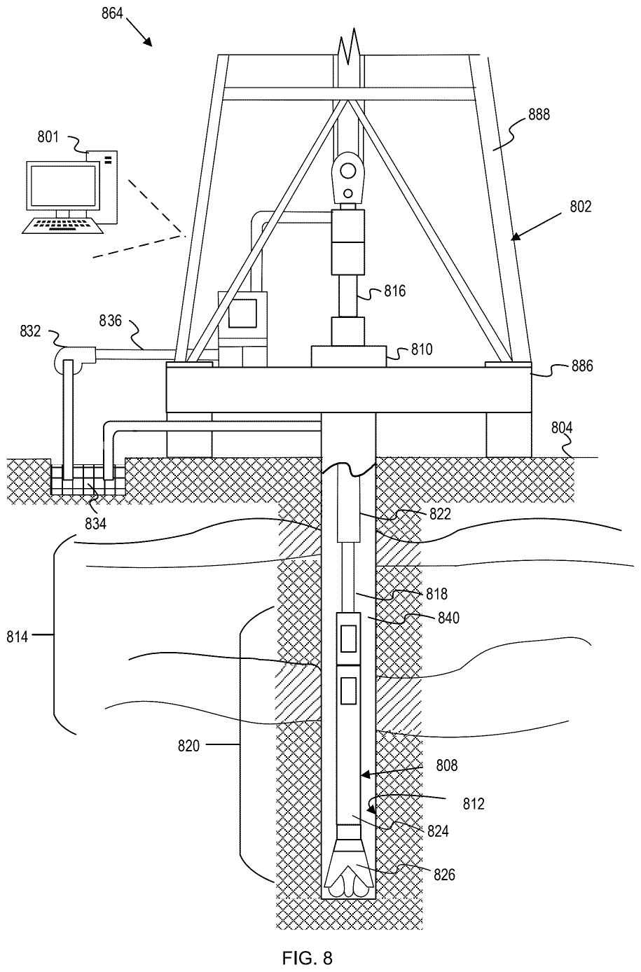

FIG. 1 depicts a schematic diagram of an example well system 100 including a geochemical logging tool, according to some implementations. In some implementations, the geochemical logging tool may include a neutron-induced gamma ray spectroscopy tool 120. In some implementations, the well system 100 may include a wellbore 102, surface equipment and tools 111, such as the computer system 110, and downhole equipment and tools, such as the neutron-induced gamma ray spectroscopy tool 120 and a downhole computing device 130. The neutron-induced gamma ray spectroscopy tool 120 may also be referred to as the spectroscopy tool 120. The well system 100 may also include a drill string 115 (or work string or other type of well tubing or pipe) that can lower the spectroscopy tool 120 downhole into the wellbore 102 (or borehole). A non-limiting example of a drilling well system that can implement the neutron-induced gamma ray spectroscopy tool 120 is described below in FIG. 8. FIG. 1 shows a portion of the wellbore 102 and well system 100 for simplicity. It is noted that the well system 100 may include additional equipment, devices, tools and other components at the surface 101 or downhole that are not shown for simplicity. The well system 100 may use the spectroscopy tool 120 for geochemical logging of the subsurface formation 150. For example, the spectroscopy tool 120 may implement neutron-induced gamma ray spectroscopy to obtain various readings of the subsurface formation spectra that indicate various properties of the subsurface formation 150, such as the elemental composition of the subsurface formation 150 (e.g., carbon composition for carbon yields). Therefore, the spectral data readings and measurements can be used for hydrocarbon reservoir evaluation, well site planning, well drilling, hydrocarbon recovery operations, and other well operations. In some implementations, the spectral data readings and measurements may be processed downhole using the downhole computing device 130, or the spectral data readings and measurements may be communicated to the surface for processing by the computer system 110.

In some implementations, the well system 100 may obtain spectral measurement data from the spectroscopy tool 120, which may be used to determine the elemental composition of the subsurface formation 150, as further described below. In some implementations, the spectroscopy tool 120 may be used in a wireline context, in a logging while drilling (LWD) context, or in a measurement while drilling (MWD) context. It is noted, however, that the spectroscopy tool 120 may be used while performing other well operations. The spectroscopy tool 120 may include a neutron source 122 that emits neutrons 126 to the subsurface formation 150. The spectroscopy tool 120 may also include a gamma ray detector 125 that can detect neutron-induced gamma rays 127. The spectroscopy tool 120 may determine the elemental composition of a formation by way of neutron-induced gamma-ray spectroscopy. Each measured spectrum may be fit to a linear superposition of elemental standards in order to extract yields. When decomposing a neutron-induced gamma ray spectrum into component spectra, one of the components is typically considered is the tool-body component spectra. For capture gamma rays, which are induced by thermal neutrons, the tool-body component can be largely eliminated by use of a thermal neutron absorbing boron shield. Such a shielding solution does not exist for inelastic gamma rays. In the case of inelastic gamma rays, a tool-body background standard is typically used in addition to the elemental standards in the fitting set for performing the spectral fit. The elemental standards may also be referred to as elemental standard spectra, and the tool-body background standard may also be referred to as the tool background standard spectrum. In some implementations, the starting point for spectral data analysis is to obtain a good spectral fit using the available standards, such as the elemental standards and the tool background standard. If the tool housing is thick, or there is a large drilling collar surrounding the spectroscopy tool 120 (such as in LWD applications), the tool background standard can be substantial percentage (e.g., approaching or exceeding 70%) of the total measured signal. Thus, accurate spectral data analysis may be dependent on using a tool background standard spectrum having the correct shape.

If the tool background standard is measured with the tool hanging-in-air, the response represents “direct” fast neutron-induced gamma rays from the housing and collar. The detector itself typically does not produce significant neutron-induced gamma rays because a thick tungsten block is usually placed between the neutron generator and detector in order to block the fast neutron beam. If the tool background standard is measured in water, the response is also mostly “direct” as the hydrogen-rich environment will limit backscattered fast neutron flux. Since the tool background standard accounts for “direct” fast neutron-induced gamma rays, the tool background standard may also be referred to as the direct tool background standard or the direct tool background standard spectrum. However, when the spectroscopy tool 120 is run in a low porosity environment with low amounts of hydrogen, a large backscattered (or reflected) fast neutron flux is typically present from the formation (e.g., such as the backscattered neutron 129). This will typically lead to significant “indirect” gamma ray production, not only in the housing and collar, but also in the detector crystal itself. In fact, the neutron-induced gamma rays from the detector crystal itself form a large component of the indirect background since they are highly likely to be detected. The effect of the indirect background may be exaggerated in LWD designs, due to the displacement of borehole fluid volume with lower hydrogen index collar material The indirect gamma rays are not accounted for in the tool-body background standard, which typically results in poor spectral fits, and thus inaccurate determination of the properties of the subsurface formation 150.

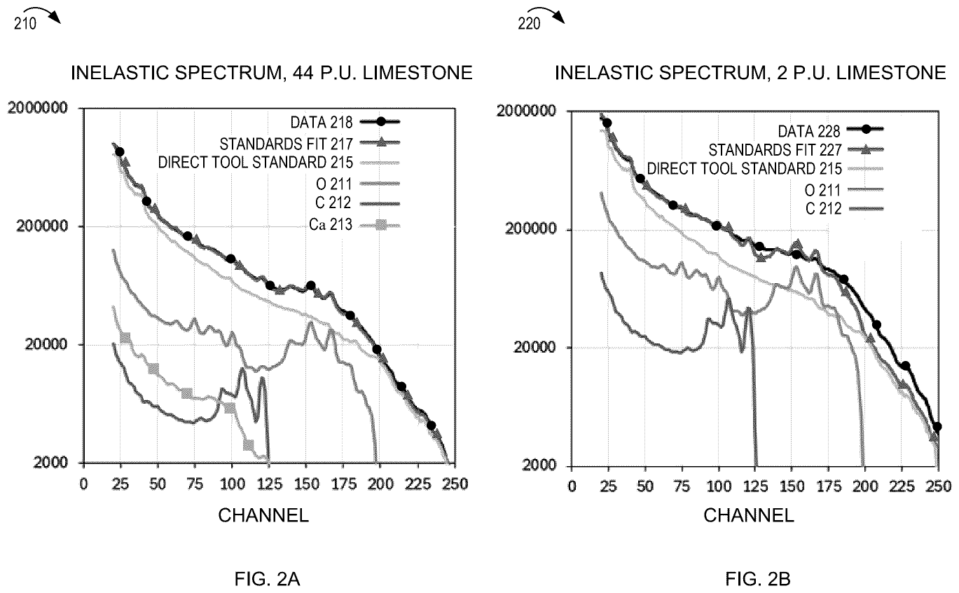

For mid and high porosity formations, using the direct tool background standard is sufficient to provide accurate spectral fits. FIG. 2A depicts an example inelastic spectral plot 210 that uses a direct tool background standard 215 and elemental standards for an accurate spectral fit when the subsurface formation has a high porosity, according to some implementations. In one non-limiting example, the subsurface formation is a limestone formation having a high porosity of 44 porosity units (P.U.). In this non-limiting example, the well system uses an LWD geochemical logging tool with a large Inconel collar, and the elemental standards are calculated using Monte Carlo N-Particle (MCNP). The elemental standards include an oxygen (O) standard 211, a carbon standard (C) 212, and a calcium (Ca) standard 213. Also, the direct tool background standard 215 is determined by measuring a spectrum in a water tank and subtracting the oxygen standard. The elemental standards and the direct tool background standard are used to create the standards fit 217, and the measured data spectrum 218 is created from measured field spectrum data. As shown in FIG. 2A, an accurate spectral fit of the standards fit 217 to the measured data 218 is achieved by using the direct tool background standard spectrum and the elemental standard spectra for a high porosity formation. For example, the spectral fit may be determined from a linear combination of the direct tool background standard spectrum and the elemental standard spectrum.

However, when the direct tool background standard 215 and the elemental standards are used for a spectral fit with measured field spectrum data from a low porosity formation, the results are a poor spectral fit. FIG. 2B depicts an example inelastic spectral plot 220 that shows a poor spectral fit when the direct tool background 215 and the elemental standards are used for a subsurface formation that has a low porosity, according to some implementations. In one non-limiting example, the subsurface formation is a limestone formation having a low porosity of 2 porosity units (P.U.). In this non-limiting example, the well system also uses an LWD geochemical logging tool with a large Inconel collar, and the elemental standards are calculated using MCNP. The elemental standards include an oxygen (O) standard 211 and a carbon standard (C) 212. Also, similar to FIG. 2A, the direct tool background standard 215 is determined by measuring a spectrum in a water tank and subtracting the oxygen standard. The elemental standards and the direct tool background standard 215 are used to create the standards fit 227, and the measured data spectrum 228 is created from measured field spectrum data. As shown in FIG. 2B, a poor spectral fit of the standards fit 227 to the measured data 228 is achieved by using the direct tool background standard spectrum and the elemental standard spectra for a low porosity formation. The poor and inaccurate spectral fit suggests that an unaccounted-for background is present, such as the indirect tool background standard, as further described below.

In some implementations, the well system 100 may achieve an accurate spectral fit to the measured spectral data obtained from subsurface formations having a variety of formation properties and attributes (e.g., low, mid or high porosities) by using the elemental standards, the direct tool background standard, and an indirect backscatter tool background standard. The indirect backscatter tool background standard may also be referred to as the indirect backscatter tool background spectrum. As described above, the direct component of the direct tool background standard may be neutron-induced gamma rays from the housing and collar. In some implementations, the indirect component of the indirect backscatter tool background standard may be from formation backscattered neutrons which subsequently hit the housing, collar, and especially the detector itself. In some implementations, the spectral contributions from the indirect tool background standard may vary as a function of the properties or attributes of the subsurface formation where the measured spectral data is obtained. For example, the spectral contributions from the indirect tool background standard may be inversely proportional (or inversely correlated) to the porosity of the subsurface formation, due to an increased prevalence of fast neutron backscatter as the formation porosity decreases. For example, in subsurface formations with mid-to-high porosities (in a non-limiting example, porosities greater than 10 PUs, such as porosities in between 10-40 PUs), there is typically enough water present to downscatter the emitted high energy neutrons (e.g., 14 MeV) such that the returning neutrons have low energy. However, at lower porosities (in a non-limiting example, porosities less than 10 Pus), there typically is not enough water to effectively downscatter the neutrons in energy, and a fast neutron flux (i.e., a high energy neutron flux) typically returns to the spectroscopy tool. The backscattering of the high energy neutron flux typically circumvents the shielding (e.g., tungsten shielding) in the spectroscopy tool. This may create a signature high-energy neutron-induced gamma ray background. For example, the signature high-energy neutron-induced gamma ray background may be created in the gamma ray detector itself (e.g., the neutrons hitting the gamma ray detector of the spectroscopy tool). Such a background may be somewhat smooth in nature due to many overlapping peaks. It is noted, however, that in other implementations the indirect backscatter tool background standard, the direct tool background standard, one or more additional tool background standards, and the elemental standards may be used to achieve an accurate spectral fit.

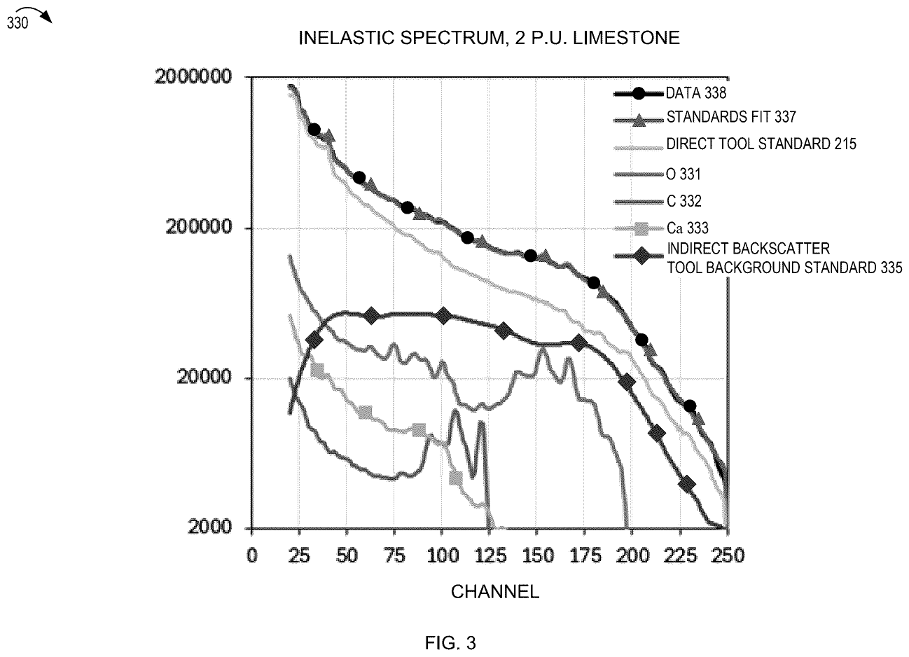

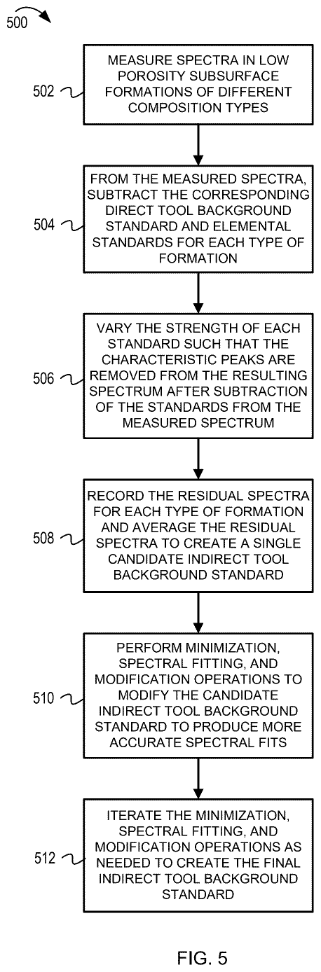

FIG. 3 depicts an example inelastic spectral plot 330 that uses an indirect backscatter tool background standard 335, a direct tool background standard 215, and elemental standards for an accurate spectral fit when the subsurface formation has a low porosity, according to some implementations. In one non-limiting example, the subsurface formation is a limestone formation having a low porosity of 2 porosity units (P.U.)(i.e., similar to the formation porosity of FIG. 2B). In this non-limiting example, the well system uses an LWD geochemical logging tool with a large Inconel collar, and the elemental standards are calculated using Monte Carlo N-Particle (MCNP). The elemental standards include an oxygen (O) standard 331, a carbon standard (C) 332, and a calcium (Ca) standard 333. Also, the direct tool background standard 215 is determined by measuring a spectrum in a water tank and subtracting the oxygen standard, and the indirect backscatter tool background standard 335 is determined by performing various processing operations that are described below in FIG. 5. The elemental standards, the direct tool background standard 215, and the indirect backscatter tool background standard 335 are used to create the standards fit 337, and the measured data spectrum 338 is created from measured field spectrum data. As shown in FIG. 3, an accurate spectral fit of the standards fit 337 to the measured data 338 is achieved by using the indirect backscatter tool background standard spectrum, the direct tool background standard spectrum, and the elemental standard spectra for a low porosity formation. For example, a linear combination of the indirect backscatter tool background standard spectrum, the direct tool background standard spectrum, and the elemental standard spectra can result in an accurate spectral fit. It is noted, however, that in other implementations the indirect backscatter tool background standard, the direction tool background standard, one or more additional tool background standards, and the elemental standards may be used to achieve an accurate spectral fit.

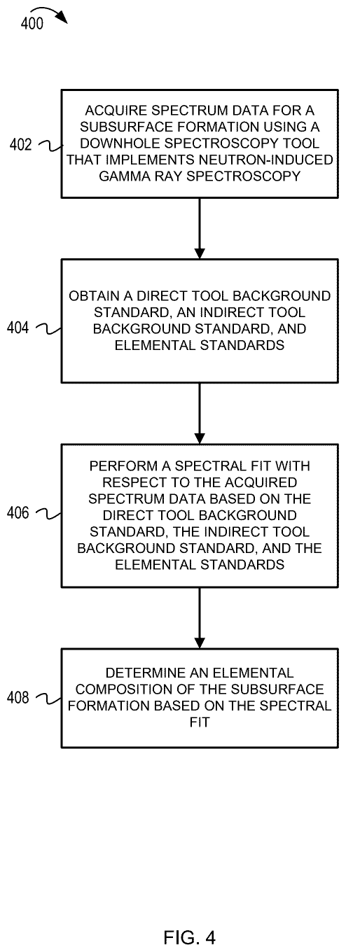

FIG. 4 depicts a flowchart 400 of example operations for using two or more tool background standards and the elemental standards for obtaining an accurate spectral fit for a subsurface formation, according to some implementations. In some implementations, the well system may acquire spectrum data for a subsurface formation using a downhole spectroscopy tool (e.g., such as the spectroscopy tool 120 of FIG. 1) that implements neutron-induced gamma ray spectroscopy (block 402). The two or more tool background standards may be two or more independent tool background standards that are independently applied to achieve an accurate spectral fit. For example, instead of combining the two or more tool background standards, and then using a single combined tool background standard for the spectral fit, the two or more independent tool background standards may be independently applied (without combining) for the spectral fit process. In some implementations, the two or more tool background standards may include an indirect backscatter tool background standard, a direct tool background standard, and one or more elemental standards. In some implementations, the well system may obtain the indirect tool background standard, the direct tool background standard, and one or more elemental standards (block 404). For example, the well system may store the indirect tool background standard, the direct tool background standard, and one or more elemental standards in a downhole computing device (such as the downhole computing device 130 described in FIG. 1) or in a surface computing system (such as the computer system 110 described in FIG. 1), and after acquiring spectra data associated with the subsurface formation, the well system may fetch or obtain the indirect backscatter tool background standard, the direct tool background standard, and one or more elemental standards from the storage or memory of the downhole or surface computing device. As described in FIGS. 1-3, the direct tool background standard and the elemental standards are determined from various simulation and/or laboratory experiments, and then stored in one or more computing devices of the well system. The operations for determining the indirect backscatter tool background standard are described below in FIG. 5.

In some implementations, the well system may perform a spectral fit with respect to the acquired spectrum data based on the indirect backscatter tool background standard, the direct tool background standard, and the elemental standards (block 406). In some implementations, the well system (e.g., the downhole computing device or the surface computing system) may perform a linear combination of the indirect tool background standard, the direct tool background standard, and the elemental standards to perform the spectral fit with respect to the acquired spectrum data. The well system may achieve an accurate spectral fit to the acquired or measured spectral data obtained from subsurface formations having a variety of formation properties and attributes (e.g., low, mid or high porosities) by using the indirect backscatter tool background standard, the direct tool background standard, and the elemental standards. As described in FIGS. 1-3, the direct component of the direct tool background standard may be neutron-induced gamma rays from the housing, collar, and/or detector. The indirect component of the indirect backscatter tool background standard may be from formation backscattered neutrons which subsequently hit the housing, collar, and/or detector. In some implementations, the spectral contributions from the indirect tool background standard may vary as a function of the properties or attributes of the subsurface formation where the measured spectral data is obtained. For example, the spectral contributions from the indirect tool background standard may be inversely proportional to the porosity of the subsurface formation, due to an increased prevalence of fast neutron backscatter as the formation porosity decreases.

In some implementations, the well system may determine an elemental composition of the subsurface formation based on the spectral fit (block 408). In some implementations, coefficients of the linear combination of the direct tool background standard, the indirect backscatter tool background standard, and the elemental standards that results in the spectral fit may be determined. In some implementations, the coefficients of the spectral fit may be referred to as yields, and the yields (or coefficients) may indicate the elemental composition of the subsurface formation, such as the carbon yields. In some implementations, the yields may be processed into weights, and the weights may be used to indicate the elemental composition of the subsurface formation. In some implementations, well operations of the well system may be determined or modified based on the determined elemental composition of the subsurface formation. For example, hydrocarbon reservoir evaluation, well site planning, well drilling, and/or hydrocarbon recovery operations may be determined or modified based on the determined elemental composition of the subsurface formation. In some implementations, well operations parameters or attributes may be determined or modified based on the determined elemental composition of the subsurface formation.

FIG. 5 depicts a flowchart 500 of example operations for deriving the indirect backscatter tool background standard, according to some implementations. In some implementations, after determining the direct tool background standard (e.g., as described above with reference to FIGS. 1-3, such as via an air or water tank technique), a spectra is measured in low porosity subsurface formations of different composition types (block 502). For example, in a simulation or in a laboratory experiment, a first spectra is measured in a low porosity subsurface formation of a sandstone composition type (which may be referred to as a low porosity sandstone formation) and a second spectra is measured in a low porosity subsurface formation of a limestone composition type (which may be referred to as a low porosity limestone formation). In some implementations, from the measured spectra for each of the different types of formations, the corresponding direct tool background standard and the corresponding elemental standards are subtracted from the measured spectra for each of the different types of formations (e.g., the sandstone and limestone formations) (block 504). For example, for the low porosity sandstone formation, the corresponding direct tool background standard and the corresponding elemental standards for the elements that are typically present in the low porosity sandstone formation are subtracted from the measured spectra for the low porosity sandstone formation. As another example, for the low porosity limestone formation, the corresponding direct tool background standard and the corresponding elemental standards for the elements that are typically present in the low porosity limestone formation are subtracted from the measured spectra for the low porosity limestone formation. As described above, in some implementations, the shape of elemental standards can be determined by MCNP calculations. In one non-limiting example, oxygen, calcium and carbon are typically present in low porosity limestone formations, and oxygen and silicon are typically present in low porosity sandstone formations.

In some implementations, the strength of each standard (e.g., the strength of both the direct tool background standard and the elemental standards) is varied such that the characteristic peaks of each standard are removed from the resulting spectrum after subtraction of the standards from the measured spectrum of the corresponding low porosity formation (block 506). In some implementations, the residual spectra is recorded for each type of formation and the residual spectra for the different types of formations is averaged to create a single candidate indirect tool background standard (block 508). In some implementations, minimization, spectral fitting, and modification operations are performed to modify the candidate indirect tool background standard to produce more accurate spectral fits (block 510). For example, using minimization software, such as chi-squared minimization software, a series of lab formation spectra is fit to the elemental standards, the direct tool background standard, and the candidate indirect backscatter tool background standard. The shape of the candidate indirect backscatter tool background standard is modified to produce more accurate spectral fits. In some implementations, the minimization, spectral fitting, and modification operations are iterated as needed to further modify (if needed) the candidate indirect backscatter tool background standard to create the final indirect tool background standard (block 512). In some implementations, a learning machine (such as a machine learning model, a machine learning neural network, or other suitable particularized machine) may be used to receive inputs and perform one or more of the operations described herein in FIG. 5, and generate one or more of the outputs described herein in FIG. 5, such as the candidate indirect backscatter tool background standards and the final indirect backscatter tool background standard. In some implementations, the learning machine or the machine learning model may include computer code and/or a neural network and be implemented on a non-transitory computer readable medium, circuitry, and/or any other logic components configured to perform the operations described herein.

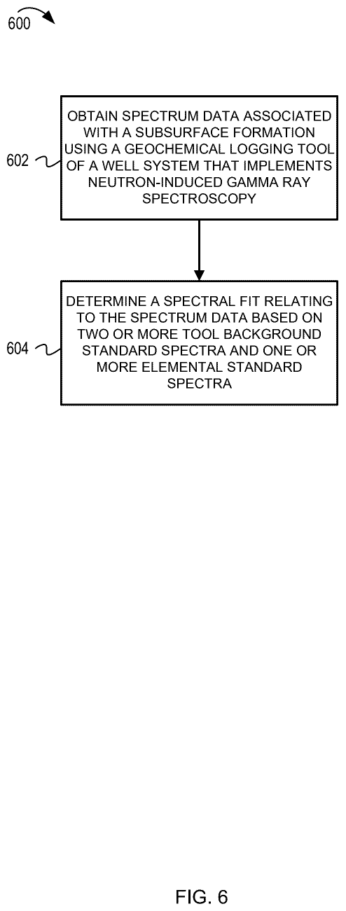

FIG. 6 is a flowchart 600 of example operations for performing geochemical logging in a well system, according to some implementations. In some implementations, spectrum data associated with a subsurface formation is obtained using a geochemical logging tool of the well system that implements neutron-induced gamma ray spectroscopy (block 602). In some implementations, a spectral fit relating to the spectrum data is determined based on two or more tool background standard spectra and one or more elemental standard spectra (block 604).

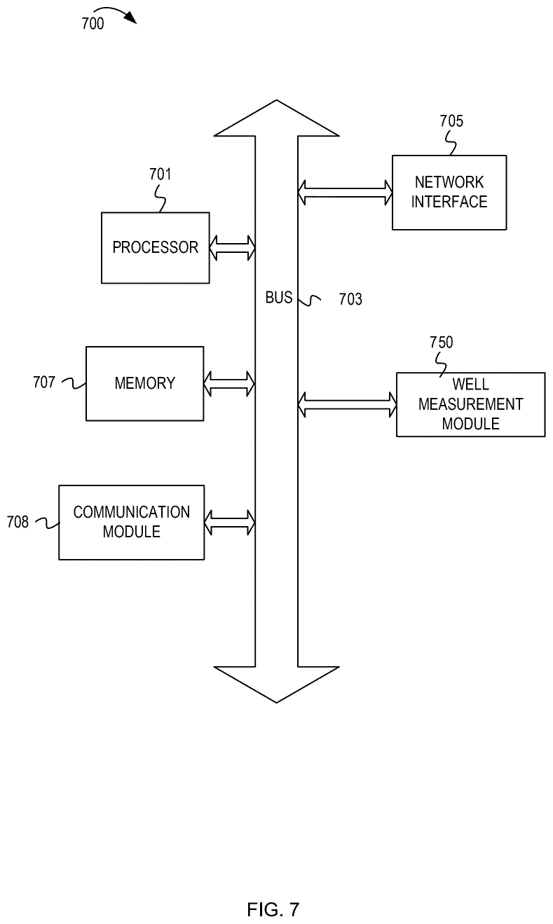

FIG. 7 depicts an example computer system of a well system for processing spectrum data obtained from a spectroscopy tool, according to some implementations. In some implementations, the computer system 700 may be an example of a computer system that may be used during the operation of the well system, such as the computer system 110 shown in FIG. 1. For example, the computer system 700 may be a standalone computer system (such as a workstation, laptop, or desktop), or may be partially or fully integrated into other surface equipment of the well system (e.g., control panel or truck). In some implementations, the computer system 700 may be implemented partially or fully in downhole components of the well system (e.g., by the downhole computing device 130 shown in FIG. 1 or within the spectroscopy tool and/or drill string and/or well tubing) or the computing functions of the computer system 700 may be distributed across both downhole components (e.g., downhole computing device 130 and/or drill string) and surface equipment (e.g., computer system 700 and/or other computer subsystem). The computer system 700 may include one or more processors 701 (possibly including multiple cores, multiple nodes, and/or implementing multi-threading, etc.). The computer system 700 may include memory 707. The memory 707 may be system memory or any type or implementation of machine or computer readable media having instructions that are executable by the one or more processors 701 to implement the operations described in FIGS. 1-6. The memory 707 may be system memory or any type or implementation of machine or computer readable and writable media having the ability to receive, process and/or store measurement data from well devices and tools (including those described in FIGS. 1-6). The computer system 700 also may include a bus 703 and a network interface 705. The computer system 700 also may include a communications module 708 that may control wired and wireless communications, such as communicating with downhole devices or tools and communicating with other surface equipment. The computer system 700 also may include at least a well measurement module 750, among other processing units or modules that are used during the operation of the well system and the well tools described herein (not shown for simplicity). The well measurement module 750 may control above ground and downhole equipment and tools to obtain measurement data, such as controlling a neutron-induced gamma ray spectroscopy tool that can take spectrum measurements downhole, as described in FIGS. 1-6. The well measurement module 750 may perform the operations described above in FIGS. 1-6 for obtaining spectrum data readings from the spectroscopy tool, and utilizing an indirect backscatter tool background standard, a direct tool background standard, and elemental standards to achieve an accurate spectral fit relating to the spectrum data. In some implementations, the well measurement module 750 (in conjunction with other control and processing units of the computer system 700) may utilize the resulting spectral fit for determining properties of the subsurface formation (e.g., determining elemental composition of the subsurface formation) and performing and/or modifying well operations (or well parameters/attributes) based on the determined properties of the subsurface formation, as described above. The functionality described herein may be implemented with an application-specific integrated circuit, in logic implemented in the processor(s) 701, in a co-processor on a peripheral device or card, etc. Further, implementations may include fewer or additional components not illustrated in FIG. 7. The processor(s) 701 and the network interface 705 may be coupled to the bus 703. Although illustrated as being coupled to the bus 703, the memory 707 may be coupled to the processor(s) 701.

FIG. 8 is a schematic diagram of a drilling rig system, as an example of oil services systems that use surface and downhole equipment. For example, in FIG. 8 it can be seen how a well system 864 may also form a portion of a drilling rig 802 located at the surface 804 of a well. Drilling of oil and gas wells is commonly carried out using a string of drill pipes connected together so as to form a drilling string 808 that may be lowered through a rotary table 810 into a wellbore or borehole 812. Here a drilling platform 886 may be equipped with a derrick 888 that supports a hoist. A computer system 801 may be communicatively coupled to the surface and downhole equipment of the well system 864. The computer system 801 may include memory (machine or computer readable media) and one or more processors, as described in FIG. 7. For example, the computer system 801 may be communicatively coupled to a neutron-induced gamma ray spectroscopy tool and a downhole computing device (which can be represented by the downhole tools 824 of FIG. 8). In some implementations, the well system 864 may use the spectroscopy tool to perform spectrum measurements, process the spectrum data, determining a spectral fit using an indirect backscatter tool background standard, a direct tool background standard, and elemental standards, and determining properties of subsurface formations based on the spectral fit, as described above with reference to FIGS. 1-7. For example, the operations described in FIGS. 1-7 may be performed in an LWD context. It is noted, however, that the operations described in FIGS. 1-7 may be performed in other contexts, such as a wireline context or a MWD context.

The drilling rig 802 may provide support for the drill string 808. The drill string 808 may operate to penetrate the rotary table 810 for drilling the borehole 812 through subsurface formations 814. The drill string 808 may include a Kelly 816, drill pipe 818, and a bottom hole assembly 820, perhaps located at the lower portion of the drill pipe 818.

The bottom hole assembly 820 may include drill collars 822, a downhole equipment or tool 824, and a drill bit 826. The drill bit 826 may operate to create a borehole 812 by penetrating the surface 804 and subsurface formations 814. The downhole tools 824 may comprise any of a number of different types of tools including MWD tools, LWD tools, and others, which may include a neutron-induced gamma ray spectroscopy tool (such as the spectroscopy tool 120 described in FIG. 1) and a downhole computing device (such as the downhole computing device 130 described in FIG. 1).

During drilling operations, the drill string 808 (perhaps including the Kelly 816, the drill pipe 818, and the bottom hole assembly 820) may be rotated by the rotary table 810. In addition to, or alternatively, the bottom hole assembly 820 may also be rotated by a motor (e.g., a mud motor) that may be located downhole. The drill collars 822 may be used to add weight to the drill bit 826. The drill collars 822 may also operate to stiffen the bottom hole assembly 820, allowing the bottom hole assembly 820 to transfer the added weight to the drill bit 826, and in turn, to assist the drill bit 826 in penetrating the surface 804 and subsurface formations 814.

Drilling operations may utilize various surface equipment, such as a mud pump 832 or other types of surface or downhole equipment. During drilling operations, the mud pump 832 may pump drilling fluid (sometimes known by those of ordinary skill in the art as “drilling mud”) from a mud pit 834 through a hose 836 into the drill pipe 818 and down to the drill bit 826. The drilling fluid may flow out from the drill bit 826 and be returned to the surface 804 through an annular area 840 between the drill pipe 818 and the sides of the borehole 812. The drilling fluid may then be returned to the mud pit 834, where such fluid may be filtered. In some implementations, the drilling fluid may be used to cool the drill bit 826, as well as to provide lubrication for the drill bit 826 during drilling operations. Additionally, the drilling fluid may be used to remove subsurface formation 814 cuttings created by operating the drill bit 826. It may be the images of these cuttings that many implementations operate to acquire and process.

Although some example well systems are described in FIGS. 1-8, it is noted, however, that the techniques and operations for performing spectrum measurements, processing the spectrum data, determining a spectral fit using various standards, and determining properties of subsurface formations described in FIGS. 1-8 can be used in any type of well system.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently.

While the aspects of the disclosure are described with reference to various implementations and exploitations, it will be understood that these aspects are illustrative and that the scope of the claims is not limited to them. In general, techniques for performing spectrum measurements, processing the spectrum data, determining a spectral fit using various standards, and determining properties of subsurface formations as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

Furthermore, unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

### Example Embodiments

Example Embodiments can include the following:

Embodiment #1: A method for performing geochemical logging in a well system, comprising: obtaining spectrum data associated with a subsurface formation using a geochemical logging tool of the well system that implements neutron-induced gamma ray spectroscopy; and determining a spectral fit relating to the spectrum data based on two or more tool background standard spectra and one or more elemental standard spectra.

Embodiment #2: The method of Embodiment #1, further comprising: determining an elemental composition of the subsurface formation based on the spectral fit.

Embodiment #3: The method of Embodiment #2, further comprising: modifying at least one of a well operation or a well operation attribute based on the determined elemental composition of the subsurface formation.

Embodiment #4: The method of Embodiment #1, wherein the two or more tool background standard spectra are independent tool background standard spectra and include at least a direct tool background standard spectrum and an indirect backscatter tool background standard spectrum.

Embodiment #5: The method of Embodiment #4, wherein the indirect backscatter tool background standard spectrum is a function of one or more properties of the subsurface formation.

Embodiment #6: The method of Embodiment #5, wherein the indirect backscatter tool background standard spectrum is inversely correlated with a porosity of the subsurface formation.

Embodiment #7: The method of Embodiment #6, wherein the indirect backscatter tool background standard spectrum accounts for a backscattering of high-energy neutrons from a low porosity subsurface formation that creates a signature high-energy neutron-induced gamma ray background.

Embodiment #8: The method of Embodiment #4, wherein the indirect backscatter tool background standard spectrum is determined based on operations performed using measured spectra associated with different composition types of subsurface formations, corresponding direct tool background standard spectra, and corresponding elemental standard spectra.

Embodiment #9: The method of Embodiment #8, wherein the operations performed using the measured spectra associated with the different composition types of subsurface formations, the corresponding direct tool background standard spectra, and the corresponding elemental standard spectra include: obtaining the measured spectra associated with the different composition types of subsurface formations; for each of the different composition types of subsurface formations, subtract the corresponding direct tool background standard spectra and the corresponding elemental standard spectra from the measured spectra to obtain a resulting difference spectra; for each of the different composition types of subsurface formations, remove characteristic peaks from the resulting difference spectra to obtain a residual spectra; average the residual spectra for the different composition types of subsurface formations; and perform minimization and fitting functions to obtain the indirect backscatter tool background standard spectrum.

Embodiment #10: The method of Embodiment #1, wherein the two or more tool background standard spectra include at least a direct tool background standard spectrum and an indirect backscatter tool background standard spectrum, and wherein determining the spectral fit relating to the spectrum data based on the direct tool background standard spectrum, the indirect backscatter tool background standard spectrum, and the one or more elemental standard spectra includes: performing a linear combination of the direct tool background standard spectrum, the indirect backscatter tool background standard spectrum, and the one or more elemental standard spectra to determine the spectral fit relating to the spectrum data; determining coefficients of the linear combination of the direct tool background standard spectrum, the indirect backscatter tool background standard spectrum, and the one or more elemental standard spectra that results in the spectral fit relating to the spectrum data; and determining an elemental composition of the subsurface formation based on the coefficients of the one or more elemental standard spectra.

Embodiment #11: A well system for performing geochemical logging, comprising: one or more processors; and a computer-readable storage medium having instructions stored thereon that are executable by the one or more processors to cause the well system to: obtain spectrum data associated with a subsurface formation using a geochemical logging tool of the well system that implements neutron-induced gamma ray spectroscopy; and determine a spectral fit relating to the spectrum data based on two or more tool background standard spectra and one or more elemental standard spectra.

Embodiment #12: The well system of Embodiment #11, further comprising instructions that cause the well system to: determine an elemental composition of the subsurface formation based on the spectral fit.

Embodiment #13: The well system of Embodiment #11, wherein the two or more tool background standard spectra are independent tool background standard spectra and include at least a direct tool background standard spectrum and an indirect backscatter tool background standard spectrum.

Embodiment #14: The well system of Embodiment #13, wherein the indirect backscatter tool background standard spectrum is a function of one or more properties of the subsurface formation.

Embodiment #15: The well system of Embodiment #14, wherein the indirect backscatter tool background standard spectrum is inversely correlated with a porosity of the subsurface formation.

Embodiment #16: The well system of Embodiment #15, wherein the indirect backscatter tool background standard spectrum accounts for a backscattering of high-energy neutrons from a low porosity subsurface formation that creates a signature high-energy neutron-induced gamma ray background.

Embodiment #17: A non-transitory computer-readable storage medium having instructions stored thereon that are executable by one or more processors of a well system, the instructions comprising: instructions for obtaining spectrum data associated with a subsurface formation using a geochemical logging tool of the well system that implements neutron-induced gamma ray spectroscopy; and instructions for determining a spectral fit relating to the spectrum data based on two or more tool background standard spectra and one or more elemental standard spectra.

Embodiment #18: The non-transitory computer-readable storage medium of Embodiment #17, further comprising: instructions for determining an elemental composition of the subsurface formation based on the spectral fit.

Embodiment #19: The non-transitory computer-readable storage medium of Embodiment #17, wherein the two or more tool background standard spectra are independent tool background standard spectra and include at least a direct tool background standard spectrum and an indirect backscatter tool background standard spectrum.

Embodiment #20: The non-transitory computer-readable storage medium of Embodiment #19, wherein the indirect backscatter tool background standard spectrum is inversely correlated with a porosity of the subsurface formation.

What is claimed is:

1. A method for performing geochemical logging in a well system, comprising:
obtaining spectrum data associated with a subsurface formation using a geochemical logging tool of the well system that implements neutron-induced gamma ray spectroscopy; and
determining a spectral fit relating to the spectrum data based on two or more tool background standard spectra and one or more elemental standard spectra.

2. The method of claim 1, further comprising:
determining an elemental composition of the subsurface formation based on the spectral fit.

3. The method of claim 2, further comprising:
modifying at least one of a well operation or a well operation attribute based on the determined elemental composition of the subsurface formation.

4. The method of claim 1, wherein the two or more tool background standard spectra are independent tool background standard spectra and include at least a direct tool background standard spectrum and an indirect backscatter tool background standard spectrum.

5. The method of claim 4, wherein the indirect backscatter tool background standard spectrum is a function of one or more properties of the subsurface formation.

6. The method of claim 5, wherein the indirect backscatter tool background standard spectrum is inversely correlated with a porosity of the subsurface formation.

7. The method of claim 6, wherein the indirect backscatter tool background standard spectrum accounts for a backscattering of high-energy neutrons from a low porosity subsurface formation that creates a signature high-energy neutron-induced gamma ray background.

8. The method of claim 4, wherein the indirect backscatter tool background standard spectrum is determined based on operations performed using measured spectra associated with different composition types of subsurface formations, corresponding direct tool background standard spectra, and corresponding elemental standard spectra.

9. The method of claim 8, wherein the operations performed using the measured spectra associated with the different composition types of subsurface formations, the corresponding direct tool background standard spectra, and the corresponding elemental standard spectra include:
obtaining the measured spectra associated with the different composition types of subsurface formations;
for each of the different composition types of subsurface formations, subtract the corresponding direct tool background standard spectra and the corresponding elemental standard spectra from the measured spectra to obtain a resulting difference spectra;
for each of the different composition types of subsurface formations, remove characteristic peaks from the resulting difference spectra to obtain a residual spectra;
average the residual spectra for the different composition types of subsurface formations; and
perform minimization and fitting functions to obtain the indirect backscatter tool background standard spectrum.

10. The method of claim 1, wherein the two or more tool background standard spectra include at least a direct tool background standard spectrum and an indirect backscatter tool background standard spectrum, and wherein determining the spectral fit relating to the spectrum data based on the direct tool background standard spectrum, the indirect backscatter tool background standard spectrum, and the one or more elemental standard spectra includes:
performing a linear combination of the direct tool background standard spectrum, the indirect backscatter tool background standard spectrum, and the one or more elemental standard spectra to determine the spectral fit relating to the spectrum data;
determining coefficients of the linear combination of the direct tool background standard spectrum, the indirect backscatter tool background standard spectrum, and the one or more elemental standard spectra that results in the spectral fit relating to the spectrum data; and
determining an elemental composition of the subsurface formation based on the coefficients of the one or more elemental standard spectra.

11. A well system for performing geochemical logging, comprising:
one or more processors; and
a computer-readable storage medium having instructions stored thereon that are executable by the one or more processors to cause the well system to:
obtain spectrum data associated with a subsurface formation using a geochemical logging tool of the well system that implements neutron-induced gamma ray spectroscopy; and
determine a spectral fit relating to the spectrum data based on two or more tool background standard spectra and one or more elemental standard spectra.

12. The well system of claim 11, further comprising instructions that cause the well system to:
determine an elemental composition of the subsurface formation based on the spectral fit.

13. The well system of claim 11, wherein the two or more tool background standard spectra are independent tool background standard spectra and include at least a direct tool background standard spectrum and an indirect backscatter tool background standard spectrum.

14. The well system of claim 13, wherein the indirect backscatter tool background standard spectrum is a function of one or more properties of the subsurface formation.

15. The well system of claim 14, wherein the indirect backscatter tool background standard spectrum is inversely correlated with a porosity of the subsurface formation.

16. The well system of claim 15, wherein the indirect backscatter tool background standard spectrum accounts for a backscattering of high-energy neutrons from a low porosity subsurface formation that creates a signature high-energy neutron-induced gamma ray background.

17. A non-transitory computer-readable storage medium having instructions stored thereon that are executable by one or more processors of a well system, the instructions comprising:
instructions for obtaining spectrum data associated with a subsurface formation using a geochemical logging tool of the well system that implements neutron-induced gamma ray spectroscopy; and
instructions for determining a spectral fit relating to the spectrum data based on two or more tool background standard spectra and one or more elemental standard spectra.

18. The non-transitory computer-readable storage medium of claim 17, further comprising:
instructions for determining an elemental composition of the subsurface formation based on the spectral fit.

19. The non-transitory computer-readable storage medium of claim 17, wherein the two or more tool background standard spectra are independent tool background standard spectra and include at least a direct tool background standard spectrum and an indirect backscatter tool background standard spectrum.

20. The non-transitory computer-readable storage medium of claim 19, wherein the indirect backscatter tool background standard spectrum is inversely correlated with a porosity of the subsurface formation.
